(19) United States
(12) Patent Application Publication
(10) Pub. No.: US 2026/0173218 A1
(43) Pub. Date: Jun. 18, 2026

(54) SELF-REGULATING ELECTRICAL HEATING CABLE

(71) Applicant: Thermon, Inc., Austin, TX (US)

(72) Inventor: Byong Jun Kim, Kyle, TX (US)

(21) Appl. No.: 19/418,291

(22) Filed: Dec. 12, 2025

Related U.S. Application Data
(60) Provisional application No. 63/733,031, filed on Dec. 12, 2024.

(51) Int. Cl. H05B 3/56

(52) U.S. Cl. CPC H05B 3/56

(57) ABSTRACT

A self-regulating electrical heating cable includes two spaced-apart electrically resistive wires extending along a length of the heating cable to generate heat from an electrical current conducted by the wires and a heating element extending along the length of the heating cable and electrically coupled to the wires to define a heating core. The heating element includes a polymer material and a thermally conductive material disposed within the polymer material to render the heating element thermally conductive to transfer the heat generated by the wires. The polymer material exhibits a positive temperature coefficient (PTC) characteristic and includes one or more PFAS-free, non-olefinic amorphous polymers, one or more PFAS-free, non-olefinic semi-crystalline polymers, or any combination thereof.

### CROSS-REFERENCE TO RELATED APPLICATION

This application claims the benefit of U.S. Patent Application No. 63/733,031 filed on Dec. 12, 2024, which is incorporated herein by reference in its entirety.

### TECHNICAL FIELD

This invention relates to heating cables and, more particularly, to self-regulating electrical heating cables.

### BACKGROUND

In general, a heat tracing system is used to compensate for heat loss caused from equipment or an object, such as a pipe or a tank, or to supply a uniform amount of heat to target equipment or a target object, thereby uniformly maintaining the temperature of the object or, in other cases, preventing the target object from being frozen or bursting. Applications of a heat tracing system include preventing frost from forming on a concrete slab, removing snow from a road, heating an indoor floor, ramp or stairs, and so forth. Heat tracing cables (used interchangeably herein with “heating cables”) are components of a heat tracing system.

Heat tracing cables can be of the “self-regulating” type, meaning that the heat output is influenced by the surface temperature of where the heat tracing cable is fitted. A warmer surface will lower the wattage output from the cable to lower the surface temperature, while a cooler surface will enable more wattage to be produced through the cable to raise the surface temperature. In other words, self-regulating heat tracing cables work by automatically altering power output in accordance with changes in the temperature of the target object they are connected to.

A conventional self-regulating heating cable is constructed to have a multi-layer structure shown as different configurations in FIGS. 1A and 1B. The self-regulating heating cables 100M (monolithic) and 100F (fiber-wrapped) depicted in FIGS. 1A and 1B, respectively, typically include the following common structural elements:
bus wires 1, which are two electrically resistive metallic wires;
heating elements 2m (FIG. 1A) and 2f (FIG. 1B) (which with the wires forms a heating core), which is a semi-conductive polymeric material comprising a conductive filler (typically carbon black with a content ranging from about 5 wt % to about 40 wt %). The heating element 2m is a monolithic design, and the heating element 2f is a fiber-wrapped design;
dielectric insulation 3, which may be similar in composition to the heating elements 2m and 2f, but free of conductive fillers, and provides electrical insulation and mechanical protection when surrounding the heating elements 2m and 2f and bus wires 1;
metallic braid mesh 4 for the purpose of grounding the electric heating cable; and
an outer jacket 5 that provides mechanical, chemical and environmental protection.

The fiber-wrapped heating element design (as depicted by way of example in FIG. 1B) may further include a non-conductive spacer 7 between the bus wires 1.

Optionally, for the fiber-wrapped design, an electrically conductive coating 8 may be applied along a length of and in electrical contact with both of the bus wires 1. This electrically conductive coating improves the efficiency of the electron transfer from the powered bus wires 1 to the semi-conductive fiber heating elements 2f. This coating may be used in the fiber-wrapped design to increase the contact between the bus wires 1 and semi-conductive fiber 2f wrapped around the bus wires. The electrically conductive coating 8 helps to reduce the loss of electrical current between the bus wires and the wrapped fiber when the bus wires are electrically powered. Such electrical coating materials are typically composed of (1) electrically conductive inorganic powder such as graphite or silver, (2) non-conductive polymer binder such as fluoroelastomer and thermoset resins, and (3) solvent such as methyl ethyl ketone and isopropyl alcohol, which are eventually evaporated after application. One example of an electrical coating material suitable for use in the fiber-wrapped design is Electrodag®.

Depending on the service temperature (i.e., temperature range of the target object that is to be maintained by the heating cable), two types of compounds are typically considered for manufacturing different elements of the self-regulating heating cables:
i) for low service temperatures (less than about 100° C.), the heating element, dielectric insulation and outer jacket are typically composed of olefinic polymers or polyolefins such as polyethylene or partially cross-linked polyethylene;
ii) for high service temperatures (from about 100° C. to about 300° C.), the heating element, dielectric insulation and outer jacket are typically composed of per- and polyfluoroalkyl substances (PFAS) based-semi-crystalline polymers (i.e., fluorinated polymers or fluoropolymers such as perfluoroalkoxy alkanes (PFA), fluorinated ethylene propylene (FEP), polyvinylidene fluoride (PVDF), and poly-ethene-cotetrafluoroethene (ETFE)).

From a structural standpoint, the heating element is typically a matrix of semi-crystalline polymers in which a certain amount of carbon black is incorporated. The combination of semi-crystalline polymers (e.g., thermoplastic) and carbon black (which has high electrical conductivity) confers a self-regulating property to the heating element. In other words, the combination of semi-crystalline thermoplastic and carbon black makes the heating element semi-conductive so that the heating element generates heat when electrical current is applied to the metallic bus wires.

As the heating element raises the temperature of the target object, the heat generation is slowed down due to the thermal expansion of the semi-crystalline thermoplastic matrix by nature. The thermal expansion of the semi-crystalline thermoplastic in the heating element is significantly high as the temperature reaches near the melting point of each semi-crystalline thermoplastic (T_{Rating} or auto shut-off temperature). As a result, the distance of conductive carbon black-to-carbon black particles in the heating element matrix eventually becomes far enough so that no further heat is generated (auto shut-off) until the heating cable cools down. This is known as positive temperature coefficient (PTC) characteristic behavior of the heating element which is constantly repeatable and reproducible.

For example, PFA-based heaters typically stop generating heat between 200° C. and 280° C. because the melting point of PFA is around 300° C. PVDF-based heaters typically stop generating heat between 100° C. and 130° C. because the melting point of PVDF is around 175° C. Polyethylene (PE polyolefin)-based heaters typically stop generating heat between 60° C. and 85° C. because the melting point of PE polyolefin is around 110-130° C. In other words, the melting point of polymer compounds in self-regulating heat tracing cables mainly determines the maximum service temperature and auto shut-off temperature (T_{Rating}) of the heat tracing cable.

Use of PFAS in different elements of conventional self-regulating heat tracing cables is advantageous thanks to its high temperature rating, excellent chemical resistance, high thermal expansion, and high flexibility. For example, some of the most popular PFAS based polymers used in the heating elements, dielectric insulation, and outer jacket are PFA, FEP, PVDF, ETFE, and partially or fully modified fluoro-co-polymers. The heating elements further include carbon black with a content ranging from about 5 wt % to about 40 wt % based on total weight of the heating element.

The semi-crystalline fluoropolymers used in PFAS-containing heating elements (e.g., PFA and FEP) typically require intensive annealing (e.g., 1-5 days at elevated temperatures) to develop a stable maximum crystallinity. In absence of such annealing, which reduces the spatial distance between the conductive filler particles, the crystalline percentage of the semi-crystalline heating elements increases during high temperature service, resulting in a change of power output from the original output at installation. In some cases, this change of power output is a continuous change, leading to higher conductivity and power output as crystallinity increases during high service temperatures.

A well-known disadvantageous characteristic of PFAS compounds is their persistence in the environment, as they are extremely resistant to degradation and have potential to accumulate in the human body and food chains with a slow degradation rate. Polyolefins are rated only for low temperature cables below 100° C. (e.g., below 65° C. for the maximum power-on pipe maintenance temperature and below 85° C. as maximum continuous power-off exposure temperature).

In view of the above processing characteristics and environmental and health concerns, especially for those exposed to these cables, there is a need for alternative PFAS-free compositions in the manufacturing of each layer of self-regulating polymeric heat tracing cables with a self-regulating performance that is comparable to the commercially available self-regulating heating cables.

### SUMMARY

This Summary is provided to introduce a selection of concepts in a simplified form that are further described below in the Detailed Description. This Summary is not intended to identify key aspects or essential aspects of the claimed subject matter.

Broadly stated, in some embodiments, the present disclosure relates to a self-regulating electrical heating cable including two spaced-apart electrically resistive wires extending along a length of the heating cable to generate heat from an electrical current conducted by the wires and a heating element extending along the length of the heating cable to encapsulate and space apart the two wires to define a heating core. The heating element includes a polymer material exhibiting a positive temperature coefficient (PTC) characteristic. The polymer material can include polyetherimide-siloxane (PEI-Si) amorphous copolymer, semi-crystalline polyaryletherketone (PAEK) polymer, semi-crystalline polyamide, thermoplastic copolyester elastomer (TPE-E), thermoplastic polyether block amides elastomer (TPE-A), a polymer blend of PEI-Si and PAEK, or any combination thereof. The heating element further includes a thermally conductive material disposed within the polymer material to render the heating element thermally conductive to transfer the heat generated by the wires.

Broadly stated, in some embodiments, the present disclosure relates to self-regulating electrical heating cable including two spaced-apart electrically resistive wires extending along a length of the heating cable to generate heat from an electrical current conducted by the wires and a heating element extending along the length of the heating cable to encapsulate and space apart the two wires to define a heating core. The heating element includes a polymer material exhibiting a positive temperature coefficient (PTC) characteristic. The polymer material is polyetherimide-siloxane (PEI-Si) amorphous co-polymer, and the heating element further includes carbon black disposed within the polymer material to render the heating element thermally conductive to transfer the heat generated by the wires.

Broadly stated, in some embodiments, the present disclosure relates to a self-regulating electrical heating cable including two spaced-apart electrically resistive wires extending along a length of the heating cable to generate heat from an electrical current conducted by the wires and a heating element extending along the length of the heating cable to encapsulate and space apart the two wires to define a heating core. The heating element includes a polymer material exhibiting a positive temperature coefficient (PTC) characteristic. The polymer material is a polymer blend of polyetherimide-siloxane (PEI-Si) amorphous co-polymer and polyether ether ketone (PEEK) semi-crystalline polymer, and the heating element includes carbon black disposed within the polymer material to render the heating element thermally conductive to transfer the heat generated by the wires.

Broadly stated, in some embodiments, the present disclosure relates to a self-regulating electrical heating cable including two spaced-apart electrically resistive wires extending along a length of the heating cable to generate heat from an electrical current conducted by the wires and a heating element extending along the length of the heating cable to encapsulate and space apart the two wires to define a heating core. The heating element includes a polymer material exhibiting a positive temperature coefficient (PTC) characteristic. The polymer material is PEEK, and the heating element further includes carbon black disposed within the polymer material to render the heating element thermally conductive to transfer the heat generated by the wires.

Broadly stated, in some embodiments, the present disclosure relates to a heat trace system including the self-regulating electrical heating cable as defined herein and a heat trace thermostat coupled to a power source and to the self-regulating electrical heating cable for regulating the electrical current flowing into the self-regulating electrical heating cable.

All features of exemplary embodiments which are described in this disclosure and are not mutually exclusive can be combined with one another. Elements of one embodiment can be utilized in the other embodiments without further mention. Other aspects and features of the present inventions will become apparent to those ordinarily skilled in the art upon review of the following description of specific embodiments in conjunction with the accompanying Figures.

### BRIEF DESCRIPTION OF DRAWINGS

A detailed description of specific exemplary embodiments is provided herein below with reference to the accompanying drawings in which:

FIG. 1A is a partially cutaway illustration of a prior-art self-regulating heating cable having a monolithic design. FIG. 1B is a partially cutaway illustration of a prior-art SR-EHT cable having a fiber-wrapped design.

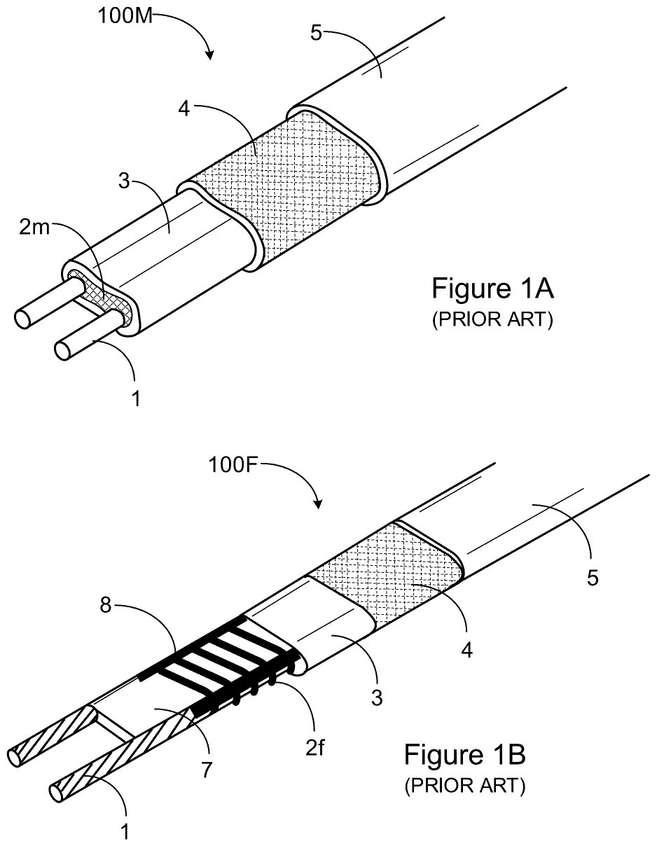

FIG. 2A is a non-limiting partially cutaway illustration of a PFAS-free, non-olefinic SR-EHT cable having a monolithic design in accordance with an embodiment of the present disclosure. FIG. 2B is a non-limiting partially cutaway illustration of a PFAS-free, non-olefinic SR-EHT cable having a fiber-wrapped design in accordance with another embodiment of the present disclosure.

FIG. 3 shows electrical percolation curves (volume resistivity in ohm·cm versus carbon black loading in wt %) for various conductive fillers.

FIG. 4 shows power output (watts/foot) for a PFAS-containing semi-crystalline SR-EHT cable and a PFAS-free amorphous SR-EHT cable as a function of length of annealing time in a 180° C. oven.

FIG. 5 is a partially cutaway illustration of a PFAS-free, non-olefinic self-regulating heating cable having a monolithic design and a barrier layer that protects the heating element and bus wires from moisture and chemical corrosion.

FIG. 6 is a flow chart showing processes for manufacturing monolithic and fiber-wrapped PFAS-free, non-olefinic SR-EHT cables.

FIG. 7 depicts an example of a heat trace system that includes a heat trace thermostat coupled to a power source and to a SR-EHT cable.

FIG. 8 shows power output by pipe temperature at 120 Vac for the heat tracing cable of Example 1 and a commercially available monolithic SR-EHT cable.

FIG. 9 shows power output by pipe temperature at 240 Vac for the SR-EHT cable of Example 1 and a commercially available monolithic SR-EHT cable.

FIG. 10 shows non-energized aging of the SR-EHT cable of Example 1.

FIG. 11 shows 120 Vac and 240 Vac continuously energized aging of the SR-EHT cable of Example 1 under 2-inch-thick fiber glass insulation.

In the drawings, exemplary embodiments are illustrated by way of example. It is to be expressly understood that the description and drawings are only for the purpose of illustrating certain embodiments and are an aid for understanding. They are not intended to be a definition of the limits of the invention.

### DETAILED DESCRIPTION

The present technology is explained in greater detail below. This description is not intended to be a detailed catalog of all the different ways in which the technology may be implemented or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art considering the instant disclosure which variations and additions do not depart from the present technology. Hence, the following description is intended to illustrate some embodiments of the technology, and not to exhaustively specify all permutations, combinations, and variations thereof.

As used herein, terms such as “comprising,” “including,” and “having” do not limit the scope of a specific claim to the materials or steps recited by the claim.

As used herein, the terms “weight percent,” “% by weight,” “weight %,” or “wt %” for each component or element of a system (e.g., a heating element) means the percentage by weight of the component or element based upon a total weight of the system (e.g., the heating element) according to the present disclosure.

As used herein, the term “high temperature” or its abbreviation “HT” refers to a temperature range from about 100° C. to about 300° C.

As used herein, the abbreviation “SR” refers to “self-regulating.”

As used herein, the term “EHT” refers to “electrical heat tracing.”

As used herein, the term “SR-EHT cables” refers to “self-regulating electrical heat tracing cables” configured to work at service temperatures either below about 100° C. or from about 100° C. to about 300° C.

As used herein, the term “HT-SR-EHT cables” refers to “high-temperature self-regulating electrical heat tracing cables” configured to work at service temperatures from about 100° C. to about 300° C.

As used herein, two wires that are “spaced-apart” are not in direct contact with each other.

As used herein, the term “about” used with respect to a number refers to a variation of ±10%.

As used herein, the term “olefinic polymers,” also known as “polyolefins,” refers to olefin polymers and copolymers, especially ethylene, propylene, and polymethylpentene polymers and copolymers, and to polymeric materials having at least one olefinic comonomer, such as ethylene vinyl acetate copolymer and ionomer, including thermoplastic olefin (TPO) or olefinic thermoplastic elastomers. Olefinic polymers (or polyolefins) can be fully or partially crosslinked by electron beam (e-beam radiation) or other crosslinking agents such as organic peroxides and silanes. Olefinic polymers (or polyolefins) can also be linear, branched, cyclic, aliphatic, aromatic, substituted, or unsubstituted. Included in these terms are homopolymers of olefin, copolymers of olefin, and copolymers of an olefin and a non-olefinic comonomer copolymerizable with the olefin (e.g., vinyl monomers, modified polymers of the foregoing), and the like.

As used herein, per- and polyfluoroalkyl substances (PFAS) is a collective name for over 3000 industrially produced chemicals. PFAS may be classified as (1) long-chain PFAS, (2) short-chain PFAS, (3) non-polymeric and polymeric fluorotelomer-based products, and (4) fluoroplastics and fluoropolymers. Long-chain PFAS include perfluoroalkane sulfonic acids (PFSAs) with carbon chain lengths of 6 and higher and perfluorocarboxylic acids (PFCAs) with carbon chain lengths of 8 and higher. Short-chain PFAS include PFSAs with carbon chain lengths of 5 and lower, and PFCAs with carbon chain lengths of 7 and lower. Fluoropolymers are, therefore, a distinct subset of PFAS.

A non-limiting list of PFAS includes perfluorobutanoic acid, perfluoropentanoic acid, perfluorohexanoic acid, perfluoroheptanoic acid, perfluorooctanoic acid, perfluorononanoic acid, perfluorodecanoic acid, perfluorobutanesulphonic acid, perfluorohexanesulphonic acid, perfluorooctanesulphonic acid, 6:2 fluorotelomer sulfonate, perfluoroundecanoic acid, perfluorododecanoic acid, perfluorotridecanoic acid, perfluorotetradecanoic acid, perfluoropentanesulphonic acid, perfluoroheptanesulphonic acid, perfluorononanesulphonic acid, perfluorodecanesulphonic acid, perfluorododecanesulphonic acid, 4:2 fluorotelomer sulfonate, 8:2 fluorotelomer sulfonate, perfluorooctanesulphone amide, N-methyl perfluorooctanesulphone amide, N-ethyl perfluorooctanesulphone amide, N-methyl perfluorooctanesulphone amide ethanol, N-ethylperfluorooctanesulphone amide ethanol, perfluorooctanesulphone amide acetate, N-methyl perfluorooctanesulphone amide acetate, N-ethyl perfluorooctanesulphone amide acetate, 7H-perfluoroheptanoic acid, perfluoro-3,7-dimethyloctanoic acid and isomers, and homologs and other permutations of these substances. The most common PFAS polymer compounds include perfluoroalkoxy alkanes (PFAs), fluorinated ethylene propylene (FEP), polyvinylidene fluoride (PVDF), poly-ethene-co-tetrafluoroethene (ETFE), and partially or fully modified fluoro-copolymers.

As used herein, the term “PFAS-free” refers to compounds that are free of PFAS.

As used herein, the term “non-fluorinated” refers to compounds that are free of fluorine atoms in their structure and are therefore considered as PFAS-free.

As used herein, the term “non-olefinic” refers to compounds that are free of “olefinic polymers” or “polyolefins” in their structure.

As used herein, for a polymer material including one or more polymers, the terms “consisting essentially of” or “consists essentially of” refer to a polymer material that includes a total amount at least 80 wt %, at least 90%, at least 95 wt %, or at least 99 wt % of the one or more polymers.

The inventors of the present disclosure, through considerable research and development, have developed PFAS-free, non-olefinic SR-EHT cables in which the polymeric component(s) for each structural element of the developed cables are according to one of the following distinct and broad embodiments, comprising, consisting essentially of, or consisting of:
I) a non-fluorinated, non-olefinic amorphous polymer or a combination of two or more non-fluorinated non-olefinic amorphous polymers
II) a non-fluorinated, non-olefinic semi-crystalline polymer or a combination of two or more non-fluorinated non-olefinic semi-crystalline polymers
III) a combination of one or more non-fluorinated, non-olefinic amorphous polymers and one or more non-fluorinated, non-olefinic semi-crystalline polymers.

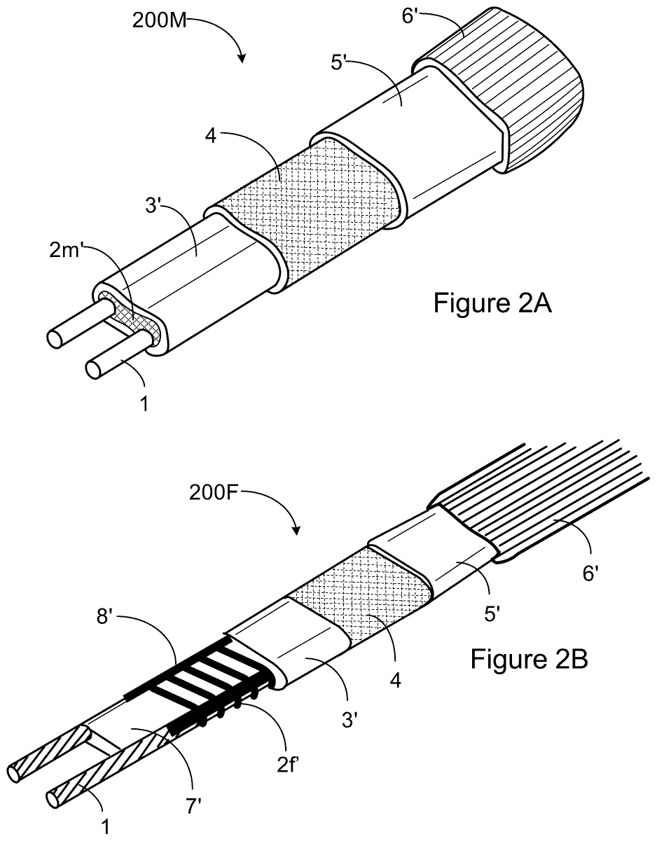

In broad embodiment III, the amorphous polymer portion in heating elements 2m′ and 2f′ as shown in FIGS. 2A and 2B, respectively, can be 10 wt % to 90 wt % (e.g., 20 wt % to 80 wt %) of the total polymer content in the heating elements, with semi-crystalline polymer making up some or all of the remainder of the total polymer content in the heating elements. The amount of semi-crystalline polymer can be selected to achieve a desired PTC rate and a desired flexibility of the cables. The selected weight ratio of amorphous polymer to semi-crystalline polymer can also be applied to the rest of the components in the HT SR-EHT cables in FIGS. 2A and 2B to achieve the desired physical and chemical properties for the selected application.

FIGS. 2A and 2B are non-limiting illustrations of PFAS-free, non-olefinic self-regulating electrical heat tracing cables in accordance with different embodiments of the present disclosure. FIG. 2A represents a non-limiting illustration of a heat tracing cable 200M with a heating element 2m′ having a monolithic design, and FIG. 2B represents a non-limiting illustration of a heat tracing cable 200F with a heating element 2f′ having a fiber-wrapped design. The heat tracing cables 200M and 200F of FIGS. 2A and 2B, respectively, include bus wires 1, heating element 2m′ or 2f′, respectively, dielectric insulation 3′, braid mesh 4, outer jacket 5′, and optional additional outer jacket 6′ for highly corrosive environments. The heat tracing cable 200F of FIG. 2B includes spacer 7′ to keep the two bus wires 1 from touching each other at the given voltage.

Different structural elements of the PFAS-free, non-olefinic SR-EHT cables according to different embodiments of the present disclosure will now be described.

### Bus Wires

The bus wires 1 depicted in FIGS. 2A and 2B include at least two electrically resistive metallic wires that generate heat when electrical current is conducted through the wires.

### Heating Element

The heating elements 2m′ and 2f′ of the PFAS-free, non-olefinic SR-EHT cables 200M and 200F depicted in FIGS. 2A and 2B, respectively, comprise non-fluorinated, non-olefinic polymer according to one of the broad embodiments I-III as stated earlier, combined with electrically conductive fillers.

In some embodiments, the conductive filler is or includes carbon black, carbon nanotubes, metal powder, or any combination thereof. In one preferred embodiment, the conductive filler is carbon black.

Within different embodiments of the heating element according to the present disclosure, the conductive filler has a content ranging from about 5 wt % to about 40 wt % based on a total weight of the heating element in order to maintain desired PTC characteristics for SR-EHT cables. The conductive filler content can be selected based at least in part on the electrical conductivity of the filler and the geometry of the heating element to achieve a selected PTC characteristic. Typically, a heating element in a fiber-wrapped SR-EHT cable, such as that depicted in FIG. 2B, contains a greater wt % of conductive filler than a monolithic cable, such as that depicted in FIG. 2A. This can be understood based on the reduced contact area between the polymeric compound of the heating element and the bus wires in a fiber-wrapped cable relative to a monolithic cable.

For example, in some embodiments, the heating element comprises “super electrically conductive” or “super conductive” carbon black, carbon nanotubes, or both embedded in the PFAS-free, non-olefinic polymer of the heating element at a content of about 3 wt % to about 10 wt % (e.g., about 5 wt % to about 8 wt %) to make a SR-EHT heating element with PTC characteristics. Examples of suitable super electrically conductive carbon blacks include KetJenblack EC-300J/EC600JD and Vulcan XCmax22. Super electrically conductive carbon black offers a highly branched morphology and extremely high surface area, which create a more efficient conductive network in the heating element polymer matrix that other particles that are less electrically conductive (e.g., electrical grade carbon blacks, such as “medium electrically conductive” or “low electrically conductive” carbon blacks). The Brunauer-Emmett-Teller (BET) surface area of super electrically conductive carbon blacks is typically in a range of about 500 m²/g to 1500 m²/g, while the BET surface area of electrical grade carbon blacks is typically in a range of about 100 m²/g to about 300 m²/g.

In some embodiments, the heating element includes medium electrically conductive or low electrically conductive carbon blacks embedded in the PFAS-free, non-olefinic polymer of a heating element at a content of about 14 wt % to about 40 wt % or (e.g., about 21 wt % to about 35 wt %) to make a SR-EHT heating element with PTC characteristics. Electrically conductive filler content in the heating element depends at least in part on the conductivity of the filler and the density of polymer matrix. That is, higher density polymers typically require a lower wt % of conductive filler (of a given electrical conductivity) to achieve selected thermal properties and PTC characteristics of SR-EHT cables. Other factors being equal, a heating element with a lower concentration of carbon black is typically more flexible than a heating element with a higher concentration of carbon black.

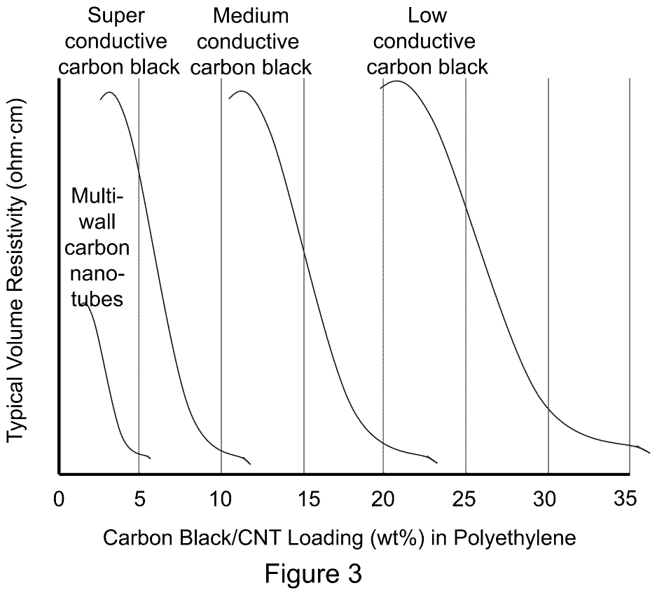

The efficiency of super electrically conductive carbon black (e.g., KetJenblack EC-300J/EC600JD and Vulcan XCmax22), multi-wall carbon nanotubes, medium electrically conductive carbon black (e.g., XC72 and Black Pearl BP2000), and low electrically conductive carbon black (e.g., most other grades) is compared in FIG. 3, which shows volume resistivity (ohm·cm) versus carbon black or carbon nanotube loading of PFAS-free, non-olefinic heating elements (wt %) in a polymer blend of PEEK and PEI-Si (e.g., as described with respect to Table 4 of Example 7 below). As shown in FIG. 3, lower loadings of the super conductive carbon black and the carbon nanotubes demonstrate electrical conductivity comparable to much higher loadings of the medium conductive carbon black and the low conductive carbon black. As such, a lower loading (wt %) of super conductive carbon black and carbon nanotubes in a polymer matrix as described herein can achieve results similar to a higher loading (wt %) of medium conductive carbon black or low conductive carbon black.

According to broad embodiment I, the polymeric components of the heating element are chosen from among non-fluorinated, non-olefinic amorphous polymers. Amorphous polymers do not have a crystalline structure and therefore, instead of having a specific melting point, they have a glass transition temperature (Tg) at which the amorphous polymer changes from a hard/glassy state to a soft state. Non-limiting examples of non-fluorinated, non-olefinic amorphous polymers are polyetherimide-siloxane (PEI-Si) copolymer, silicone thermoset elastomer, and polymer blends of different grades of PEI-Si copolymers or of PEI-Si copolymer and silicone elastomer. In this disclosure, polyetherimide-siloxane may also be referred to as polyetherimide-silicone. Unlike semi-crystalline polymers, which have a specific melting point, amorphous thermoplastics (e.g., PEI-Si copolymer) have a glass transition temperature (Tg) typically ranging from about 130° C. to about 220° C. Different grades of PEI-Si copolymers having different Tgs may be blended for a target optimum Tg that results in desired thermal properties and PTC characteristics. For a high temperature SR-EHT cable, the preferred range of Tg for the amorphous heating element system is about 170° C. to about 200° C.

In one example, HT SR-EHT cables with a non-fluorinated, non-olefinic amorphous polymer having a Tg of 185° C. can generate heat up to about 185° C. with PTC characteristics, generating less heat as the temperature increases to approach the Tg. Above about 185° C., the polymer matrix of the heating element expands sufficiently to inhibit or prevent automatic generation of heat.

For broad embodiment I, the non-fluorinated, non-olefinic amorphous polymers can be used separately or combined to achieve a selected Tg for desired thermal properties and PTC characteristics. In some binary blends, the two polymers have a content of 20 wt % to 80 wt % each. For multi-polymer blends with more than two polymers (e.g., tertiary blends or higher), each polymer typically has a content of at least 10 wt %. This selective combination can be used to achieve effective synergy of compatibilized polymers.

The non-fluorinated, non-olefinic amorphous polymer(s) is typically mixed with a selected amount of carbon black using compounding machinery (e.g., twin-screw extruders), to make raw material pellets of material for the heating elements. These pelletized raw materials may then be extruded with metallic bus wires to make SR-EHT cables. Advantageously, the formulations of the heating element polymers using non-fluorinated, non-olefinic amorphous polymers described herein do not require the intensive and extensive annealing process during manufacturing stage described herein for PFAS fluoropolymer heating elements. The presence of amorphous polymers in the heating elements of embodiment 1 can reduce or eliminate the need for annealing during processing, and result in more consistent power output. —

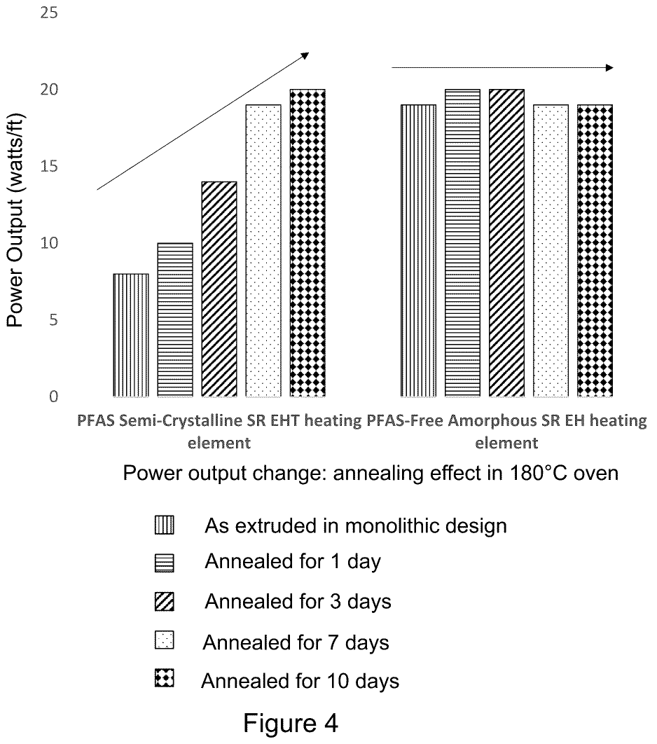

FIG. 4 provides a comparison of power output (watts/foot) of a monolithic SR-EHT cable with a heating element made of a perfluoroalkoxy (PFA) semi-crystalline polymer containing 15 wt % of a medium conductive carbon black and the monolithic PFAS-free, non-olefinic amorphous SR-EHT cable of Table 1 for different lengths of annealing time in a 180° C. oven. As shown in FIG. 4, power output increases as crystallinity increases with annealing time from zero to for 1, 3, 7 and 10 days. In contrast, the power output of PFAS-free amorphous polymer heating elements does not change significantly based on length of annealing time. Notably, the power output of the PFAS-free, non-olefinic amorphous polymer heating element is essentially the same before annealing and at various lengths of annealing up to 10 days. As such, PFAS-free, non-olefinic amorphous polymer heating elements may be advantageously fabricated without undergoing annealing. This difference is believed to be due to the lack of crystallinity in the amorphous polymer heating elements.

According to broad embodiment II, the polymeric components of the heating element are chosen from among non-fluorinated, non-olefinic semi-crystalline polymers. Non-limiting examples of non-fluorinated, non-olefinic semi-crystalline polymers include polymers from the polyaryletherketone (PAEK) family, the polyamide (PA) family, thermoplastic copolyester elastomers (TPE-E), and thermoplastic polyether block amides elastomers (TPE-A). In a preferred embodiment, the semi-crystalline polymer is selected from the PAEK family or the PA family due at least in part to the higher temperature resistance and chemical resistance of these polymers than TPE-E and TPE-A.

Polyaryletherketone (PAEK) is a family of semi-crystalline thermoplastics whose molecular backbone contains ketone (R-CO-R) and ether groups (R-O-R). The linking group R between the ketone and ether functional groups includes a 1,4-substituted aryl group, and can be modified for better flexibility and ductility. As a family of semi-crystalline thermoplastics, PAEK melting points typically range from about 280° C. to 380° C. A non-limiting list of semi-crystalline thermoplastics in the PAEK family includes: polyether ether ketone (PEEK) and/or its plasticized copolymer, polyether ketone ketone (PEKK) and/or its plasticized copolymer, polyether ketone (PEK) and/or its plasticized copolymer, polyether ether ketone ketone (PEEKK) and/or its plasticized copolymer, polyether ketone ether ketone ketone (PEKEKK) and/or its plasticized copolymer, and modifications of these and other PAEK based polymers. In a preferred embodiment, PEEK is used as a non-fluorinated, non-olefinic semi-crystalline polymer due at least in part to its moderate flexibility with tensile elongation 5% to 50% at ambient and its ductility and ability to be used continuously at service temperatures up to about 250° C. or even higher (e.g., up to 350° C.).

In some implementations, a blend of two or more semi-crystalline polymers in the PAEK family, with varying levels of flexibility, is used in the manufacturing of SR-EHT cables in order to achieve a desired flexibility and bending diameter at a selected temperature. Other polymer components can be present (e.g., in a range of about 5 wt % to about 50 wt %).

In some implementations, in order to enhance the flexibility of PAEK family polymers, modified/plasticized PAEK co-polymers are also included.

In some preferred embodiments, the semi-crystalline polymers within the polyamide (PA) family include polyamide 11, polyamide 12, and reactive blends of PA and other anhydride-modified semi-crystalline polymers (e.g., maleic anhydride grafted polyethylene and maleic anhydride grafted TPE) to improve flexibility and lower moisture absorption. Heating elements that are PA based can be used continuously at service temperatures up to about 150° C. or even higher (e.g., up to 250° C.) with PA46 or 66.

In some preferred embodiments, a semi-crystalline polymer in the TPE family is chosen from among the thermoplastic co-polyester elastomers (TPE-E) and thermoplastic polyether block amides elastomers (TPE-A). Heating elements that are TPE based can be used continuously at service temperatures up to about 150° C. or even higher (e.g., up to 180° C.) with thermoplastic vulcanizates (TPVs) based on acrylate rubber and polyester.

According to broad embodiment III, the polymeric components of the heating element are blends of non-fluorinated, non-olefinic amorphous polymers and non-fluorinated, non-olefinic semi-crystalline polymers.

In some embodiments, polyaryletherketone (PAEK) as a non-fluorinated, non-olefinic semi-crystalline polymer is blended with non-fluorinated, non-olefinic amorphous PEI-Si.

In some embodiments, polyamide (PA) is blended with anhydride modified amorphous polymers (e.g., maleic anhydride grafted TPE) to improve its flexibility and lower moisture absorption.

In one implementation, as shown in FIG. 2A, the polymeric component of the heating element 2m′ is extruded over the metallic bus wires 1, thereby encapsulating the metallic bus wires in the polymeric component. As used herein, “encapsulating” refers to enclosing the metallic bus wires in the polymeric component along a length of the metallic bus wires. That is, “encapsulated” metallic bus wires may have exposed portions at the ends of a heating element.

In another implementation, as shown in FIG. 2B, the polymeric component of the heating element 2f′ is in the form of a fiber wrapped around the metallic bus wires 1. The diameter of the fiber strand depends at least in part on the intended power output. A larger diameter of the fiber strand generally allows a higher power output. The diameter of the fiber strand is typically in a range of about 0.5 mm (0.02 inch) to about 3 mm (0.12 inch). The density of fiber wraps (e.g., the number of wraps around the assembly of the spacer and bus wires per unit length of the heating cable) can be selected based at least in part on the intended power output. The density of fiber wraps in a 25.4 mm (1 inch) length of SR-EHT cable is typically in a range of 3 to 15. Other factors being equal, more densely wrapped fiber generates more power. A more “densely wrapped” fiber refers to a fiber having a greater number of wraps per unit length of a heating cable.

For efficient transfer of electric current between the metallic bus wires and polymeric PTC fibers, a PFAS-free electrically conductive paint coating 8′ can be optionally applied as illustrated in FIG. 2B. This optional, electrically conductive paint coating can be applied along a length and in contact with bus wires 1 on one or both sides of the cable as shown by the arrows in FIG. 2B. The electrically conductive paint coating 8′ is a mixture of volatile solvent-diluted-adhesive binder and electrically conductive particles (e.g., Electrodag®, available from Acheson Colloids Company) at the interface between the metallic bus wires 1 and PTC polymer fiber strands 2f′. The non-fluorinated, non-olefinic solvent-diluted-adhesives in the electrically conductive paint may include, for example, acrylic, silicone, epoxy, and phenolic resins as binders that do not introduce any unwanted PFAS chemicals such as a fluoropolymer elastomer. In one example, the electrically conductive paint is free of FKM elastomer binder, a PFAS synthetic rubber that is a copolymer of vinylidene fluoride and hexafluoropropylene.

A typical composition of a PFAS-free electrically conductive material, which is used for the PFAS-free electrically conductive paint coating 8′ in FIG. 2B, is (i) 50 wt % to 90 wt % of a volatile solvent (e.g., methyl ethyl ketone (MEK), isopropanol, butyl acetate, acetone, toluene, etc.), (2) 3 wt % to 30 wt % of conductive powder(s), and (3) 3 wt % to 30 wt % of PFAS-free polymeric binder(s). After coating and drying, the volatile solvent is evaporated, such that electrically conductive paint coating 8′ in FIG. 2B includes highly concentrated electrically conductive powder(s) and polymeric binder. The concentration of the electrically conductive powder(s) is typically in a range of about 30 wt % to about 70 wt % and the remaining is a PFAS-free polymeric binder.

### Dielectric Insulation Layer

The polymeric component(s) of the dielectric insulation 3′ (or dielectric insulation layer) of the SR-EHT cables 200M and 200F depicted in FIGS. 2A and 2B, respectively, may be substantially similar to the polymeric component(s) of heating elements 2m′ and 2f′, respectively. The dielectric insulation 3′ is free of carbon black and other electrically conductive fillers.

A non-limiting list of polymers that may be used for the dielectric insulation 3′ includes silicone (Si) thermoset elastomer, polyetherimide-silicone copolymer (PEI-Si), a blend of PEI-Si and a PAEK family polymer (preferably PEEK), polyamide (PA) (e.g., preferably PA 11 or PA blend with anhydride grafted non-fluorinated polymers), thermoplastic copolyester elastomers (TPE-E), thermoplastic polyether block amide elastomers (TPE-A), and any combination thereof.

In one implementation, the dielectric insulation layer is separately extruded over the extruded monolithic heating element 2m′ or fiber heating element 2f′.

In one implementation, the dielectric insulation layer is co-extruded along with the heating element 2m′.

### Braid

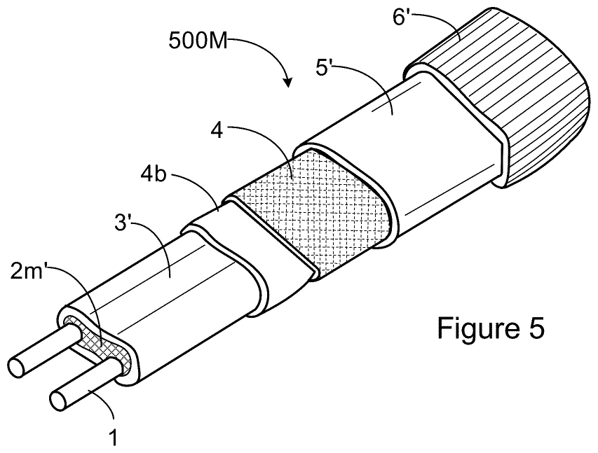

The braid, or braid mesh, 4 as depicted in FIGS. 2A and 2B is an electrically conductive metallic mesh used for the purpose of grounding the heating cable. In some embodiments, the braid mesh 4 is nickel-plated copper. In some embodiments, the braid mesh is tin-plated copper. In some embodiments, as depicted in fiber-wrapped heat tracing cable 500M in FIG. 5, the braid mesh 4 is nickel- or tin-plated copper used together with a barrier layer 4b (e.g., applied separately underneath the braid mesh 4). The barrier layer 4b advantageously provides strength, heat and moisture resistance, thermal and electrical shielding, and electrical conductivity. In one example, the barrier layer 4b is an aluminum/polymer laminated tape or film. In one example, the barrier layer is a composite tape with a polyethylene terephthalate (PET) film backing and an aluminum foil layer (e.g., Electrolock EJ Aluminum Laminate, available from Electrolock, Inc.).

The barrier layer 4b is positioned between the dielectric insulation layer 3′ and the braid mesh 4, and acts as a barrier layer between the dielectric insulation layer and the braid mesh, protecting the dielectric insulation layer 3′, the heating element 2m′, and the bus wires 1 from moisture and chemicals that could alter the properties of one or more of these components. Although FIG. 5 depicts the barrier layer 4b in combination with a monolithic heating element, a barrier layer can also be used with the fiber wrapped design of FIG. 2B. The barrier layer 4b is especially suitable in heating cables that include hydrophilic polymer(s) in the heating element and dielectric insulation layer.

### Outer Jacket

A non-limiting list of polymers that may be used for outer jacket layer 5′ in FIGS. 2A and 2B includes silicone (Si) thermoset elastomer, polyetherimide-silicone copolymer (PEI-Si), a blend of PEI-Si and a PAEK family polymer (preferably PEEK), polyamide (PA) (e.g., preferably PA 11 or PA blend with anhydride grafted non-fluorinated polymers), thermoplastic copolyester elastomers (TPE-E), thermoplastic polyether block amides elastomers (TPE-A), or any combination thereof.

In one implementation, the outer jacket 5′ is extruded over the metallic braid mesh 4.

### Additional Outer Jacket

In some implementations, the self-regulating electrical heat tracing cable according to the present disclosure depicted in FIGS. 2A and 2B may optionally include an additional outer jacket 6′ for environmental protection.

In some embodiments, the additional outer jacket 6′ is extruded over the outer jacket 5′. The extruding thickness of the additional outer jacket 6′ may be in a range between 0.05 mm (0.002″) and 0.5 mm (0.020″), preferably less than 0.25 mm (0.010″) to keep flexibility and lower cost of the self-regulating electrical heat tracing cable.

In some embodiments, the additional outer jacket 6′ is a thin layer of polyaryletherketone (PAEK) (e.g., preferably PEEK, modified, crosslinked, or plasticized PEEK, or its copolymer in the PAEK family) for a high level of chemical/water resistance and mechanical toughness.

In some embodiments, the additional outer jacket 6′ is a thin layer polyamide (PA) (e.g., preferably PA 11, 12, or a PA blend with anhydride grafted non-fluorinated polymers) for a high level of chemical resistance and mechanical toughness.

### Spacer

The spacer 7′ is located between two bus wires 1 as shown by way of example in FIG. 2B. The spacer 7′ is an electrically non-conductive polymeric spacer made of non-fluorinated, non-olefinic polymers such as, for example, polyamides, PEI-Si, PAEK family polymers, a blend of PEI-Si and PEEK, silicone elastomer, and mixtures thereof. For better physical stability of the spacer 7′ in a fiber-wrapped design, electrically non-conductive reinforcing fillers can be mixed with the selected non-fluorinated, non-olefinic polymers. Suitable examples of non-conductive reinforcing fillers include fiber glass, silica, clay, calcium carbonates, alumina silicate, boron nitride, aluminum oxide, or the like. A typical amount of the non-conductive reinforcing filler(s) in the spacer 7′ is in the range of about 10 wt % to about 70 wt % based on the weight of the spacer 7′, although this may vary.

### Manufacturing Method

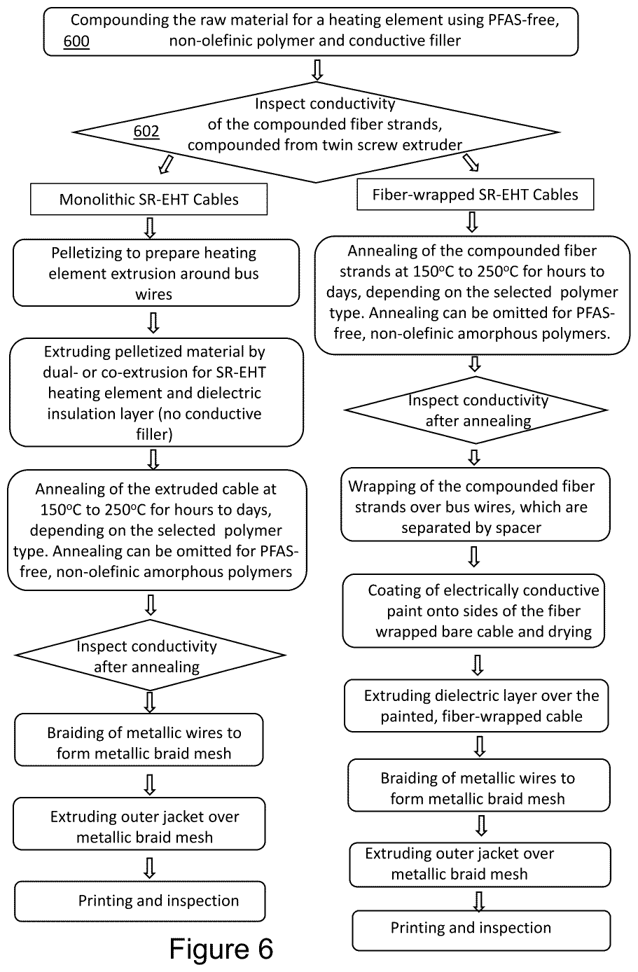

FIG. 6 is a flowchart showing operations in embodiments of processes for manufacturing PFAS-free, non-olefinic monolithic and fiber-wrapped SR-EHT cables. In 600, PFAS-free, non-olefinic polymer and conductive filler are compounded and extruded in a twin screw extruder to yield compounded fiber strands. In 602, the electrical conductivity of the compounded fiber strands is inspected for suitability in SR-EHT cables. These compounded fiber strands can be used to form heating elements for monolithic SR-EHT cables and fiber-wrapped SR-EHT cables.

For monolithic SR-EHT cables, the compounded fiber strands are pelletized in preparation for extrusion of the monolithic heating element around the bus wires. The pelletized material is extruded by dual or co-extrusion with pelletized polymer (no conductive filler) to form the monolithic heating element covered with the dielectric insulation layer. For SR-EHT cables of broad embodiments II and III, both of which contain semi-crystalline PFAS-free, non-olefinic polymers, the extruded cable is annealed at 150° C. to 250° C. for a length of time (e.g., hours to days) depending on the selected polymer composition. For SR-EHT cables of broad embodiment I (PFAS-free, non-olefinic amorphous polymers), no annealing is necessary, and annealing can be omitted. The electrical conductivity of the cable is then inspected for suitability in SR-EHT cables. The cables are then covered with metallic braid mesh, and a PFAS-free, non-olefinic outer jacket is extruded over the metallic braid mesh. An additional outer jacket is optionally extruded over the outer jacket. The completed cable is then labeled (e.g., printed) and inspected again.

For fiber-wrapped SR-EHT cables of broad embodiments II and III, both of which contain semi-crystalline PFAS-free, non-olefinic polymers, the compounded fiber strands are annealed at 150° C. to 250° C. for a length of time (e.g., hours to days) depending on the selected polymer composition. For fiber-wrapped SR-EHT cables of broad embodiment I (amorphous PFAS-free, non-olefinic polymers), no annealing is necessary, and annealing can be omitted. The electrical conductivity of the compounded fiber strands is then inspected for suitability in SR-EHT cables. The compounded fiber strands are then wrapped over bus wires, which are separated by an electrically non-conductive PFAS-free, non-olefinic polymeric spacer. An electrically conductive paint is then applied to both sides of the fiber-wrapped bare cable, and the paint is dried. A dielectric layer is then extruded over the painted, fiber-wrapped cable, The fiber-wrapped cable then covered with metallic braid mesh, and a PFAS-free, non-olefinic outer jacket is extruded over the metallic braid mesh. An additional outer jacket is optionally extruded over the outer jacket. The completed cable is then labeled (e.g., printed) and inspected again.

### Heat Trace System

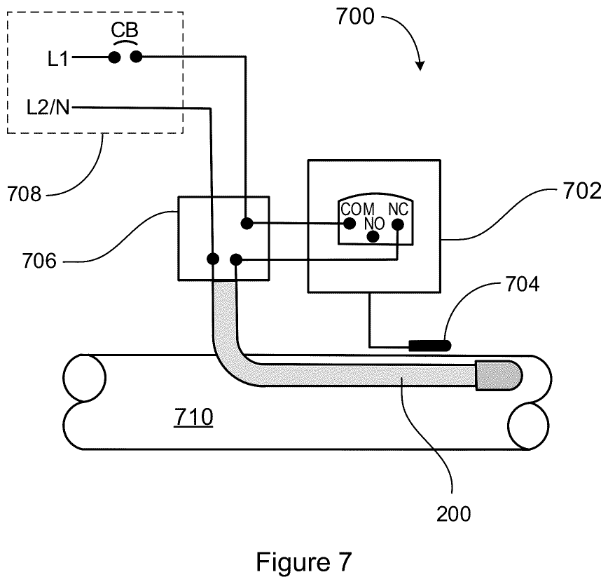

The self-regulating heat tracing cables may be used in a heat trace system, such as heat trace system 700 depicted in FIG. 7. The heat trace system 700 includes at least one PFAS-free, non-olefinic self-regulating heating cable 200 (e.g., heating cable 200M or heating cable 200F) and a heat trace thermostat 702 with thermostat sensor 704 coupled to a heat tracing junction box 706. The heat trace thermostat 702 includes common terminal COM, normally open contact NO, and normally closed contact NC. The heat tracing junction box 706 is configured to be in electrical communication with power source 708 (where L1=line 1, L2=line 2/neutral, and CB=circuit breaker) and to the self-regulating heating cable 200 for regulating the electrical current flowing into the self-regulating heating cable. In this example, heating cable 200 is thermally coupled to and configured to heat pipe 710 during operation.

Some specific examples of self-regulating heating cables are presented below. Although the test results provided herein demonstrate the effectiveness of PEEK, PEI-Si, and blends thereof, other PFAS-free, non-olefinic polymers can be used to provide desired PTC characteristics for self-regulating cables when a conductive filler such as carbon black is mixed with or embedded into the polymer. In another embodiment, a semi-crystalline polyamide with a conductive filler such as carbon black will exhibit similar thermal expansion properties and will thus also provide desired PTC characteristics for self-regulating cables. In a further embodiment, a thermoplastic copolyester elastomer (TPE-E) with a conductive filler like carbon black will exhibit similar thermal expansion properties and will thus also provide desired PTC characteristics for self-regulating cables. In another embodiment, a thermoplastic polyether block amide elastomer (TPE-A) with a conductive filler like carbon black will exhibit similar thermal expansion properties and will thus also provide desired PTC characteristics for a self-regulating cable.

### EXAMPLES

### Example 1

In this first example embodiment, self-regulating heat tracing cables were manufactured using non-fluorinated, non-olefinic amorphous polymers in accordance with broad embodiment I of the present disclosure. The detailed components and the cable specifications of this first example embodiment are summarized in Table 1. As shown in Table 1, all polymeric components of the heating cable (heating element, dielectric insulation, and outer jacket) are made of polyetherimide-siloxane (PEI-Si) copolymer or polymer blend of different grades of PEI-Si copolymers representing non-fluorinated, non-olefinic amorphous polymers. The SR-EHT amorphous cable in Table 1 was not subjected to an annealing process. To measure initial power output, the manufactured cables were placed on a flow pipe test fixture at 240 Vac and a flow pipe temperature of 10° C. (50° F.).

TABLE 1
Components and specifications of the SR-EHT cable of Example 1

| Component | | | | | | Initial | |
|---|---|---|---|---|---|---|---|
| (and No.) in | | Composition | | Electric | | Power | Auto shut- |
| FIG. 2A | | of each | Component | resistance of | Applied | Output (at | off |
| monolithic | Material | component | thickness | cable (Ω/m | voltage | 10° C.) at | temperature |
| design | type | (wt %) | (mm) | at 20° C.) | (Vac) | Vac (W/m) | (° C.) at Vac |
| Bus wires (1) | Ni plated | NA | | 1000 | 240 | 60 | 175 |
| | 16 AWG | | | | | | |
| | Cu wires | | | | | | |
| Amorphous | PEI-Si | 84 | 0.6 | | | | |
| PTC heating | Medium | 16 | | | | | |
| element (2) | conductive | | | | | | |
| | carbon | | | | | | |
| | black | | | | | | |
| Amorphous | PEI-Si | 100 | 1.5 | | | | |
| dielectric | | | | | | | |
| insulation (3) | | | | | | | |
| Braid (4) | Ni plated | 100 | 0.5 | | | | |
| | Cu wire | | | | | | |
| | braid | | | | | | |
| Amorphous | PEI-Si | 100 | 0.55 | | | | |
| outer jacket | | | | | | | |
| (5) | | | | | | | |
| Additional | None | Not used | NA | | | | |
| outer jacket | | | | | | | |
| (6) | | | | | | | |

To test the PTC characteristics of the monolithic PFAS-free, non-olefinic SR-EHT cable manufactured according to Table 1, the power output of the cable was assessed as a function of temperature at 120 Vac and 240 Vac. The power output like 3-1, 6-1, 15-1, 20-1 or all -2 are measured at 50° F. (10° C.) per the industry IEEE 515 and IEC/IEEE 62395-1:2024 standard.

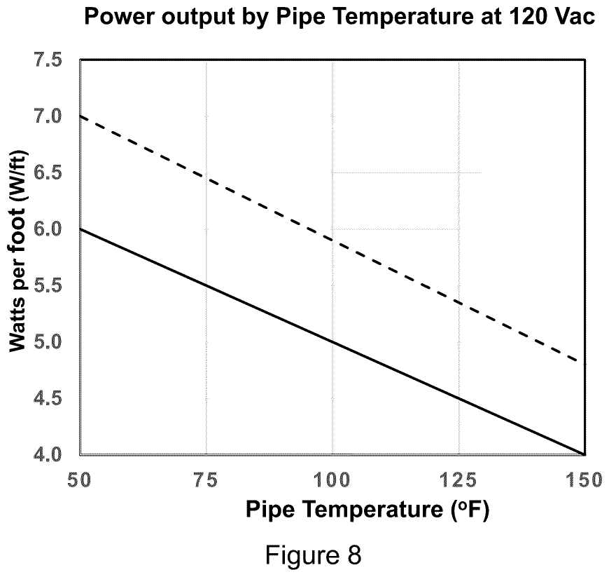

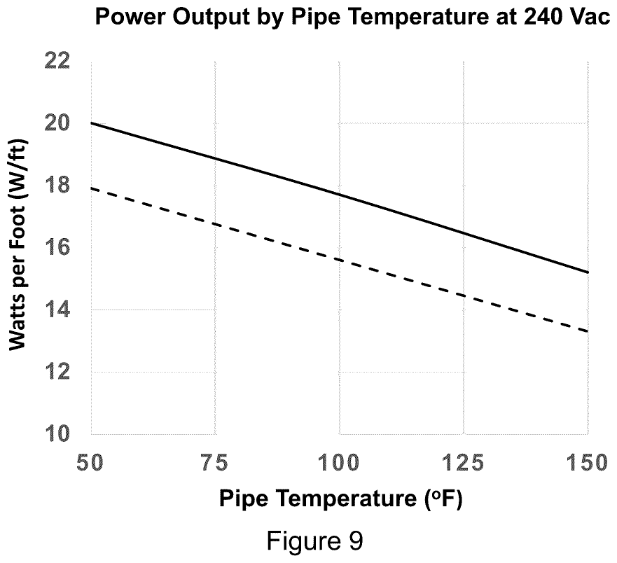

FIG. 8 shows power output (watts per foot) by pipe temperature (° F.) at 120 Vac for a monolithic PFAS-free, non-olefinic SR-EHT cable manufactured according to Table 1 (dotted line), and also for a monolithic PFAS-containing commercially available SR-EHT cable (HTSX™ 6-1 by Thermon) as a reference (solid line). Here, “-1” means 120 Vac application, while “6” means 6 watts/ft at 120 Vac, where the power output is measured at 50° F. (10° C.) per IEC/IEEE 62395-1:2024. Both heat tracing cables show a linear decrease in power output with an increase in pipe temperature and have a similar slope. FIG. 9 shows power output (watts per foot) by pipe temperature (° F.) at 240 Vac for a monolithic PFAS-free, non-olefinic SR-EHT cable manufactured according to Table 1 (dotted line), and also for a monolithic PFAS-containing commercially available SR-EHT cable (HTSX™ 20-2 by Thermon) as a reference (solid line). Here, “-2” means 240 Vac application, while “20” means 20 watts/ft at 240 Vac, where the power output is measured at 50° F. (10° C.) per IEEE 515 and IEC/IEEE 62395-1:2024. Both heat tracing cables show a linear decrease in power output with an increase in pipe temperature and have a similar slope. Thus, the monolithic PFAS-free, non-olefinic SR-EHT cable manufactured according to Table 1 demonstrates self-regulating PTC behavior similar to that of a monolithic PFAS-containing SR-EHT cable.

### Example 2

In this example embodiment, a self-regulating cable manufactured according to the specifications in Table 1 was subjected to a hot-cold cycling test. To do so, the cable was preconditioned by being energized at 240 Vac on a rack at room temperature for 20 hours. Next, the cable was subjected to 5000 cycles (30 minutes on a hot plate maintained at 150° C. and 30 minutes on a cold plate maintained at 21° C. (70° F.)) while being energized continuously at 240 Vac. After every 100 cycles, cycling was paused while the cable was moved to the cold plate (70° F.) and powered off for 3 hours prior to steady state power output measurements. After each measurement, cycling was resumed until the next pause and power output measurement. The cycling test results confirmed intact PTC characteristic of the cable.

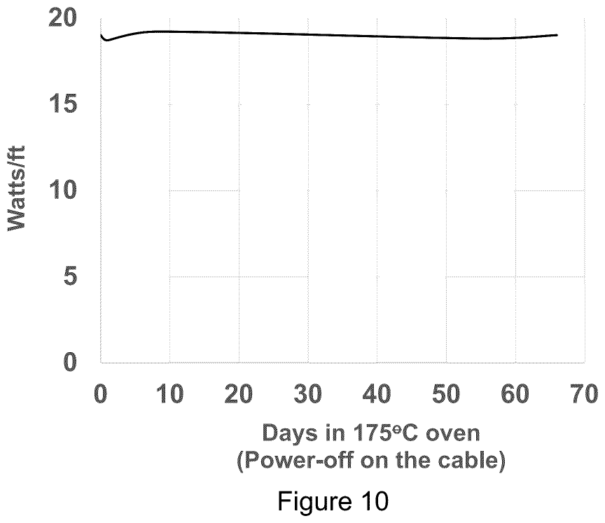

A cable manufactured according to the specifications in Table 1 was subjected to the non-energized passive aging test by being placed in a 175° C. oven for a total of 66 days. The cable was taken out from the aging oven after an interval of 3-7 days and allowed to cool for 24 hours to an ambient temperature. The power output change was then measured at 240 Vac throughout the passive (power-off) aging. After the measurement, the cable was placed back in the 175° C. oven for another interval of 3-7 days. This process was repeated for a total of 66 days in the oven. As shown in FIG. 10, the power output was consistent throughout the non-energized passive aging in the 175° C. oven, demonstrating that the cable manufactured according to Example 1 can be rated as high as 175° C. as a power-off exposure temperature.

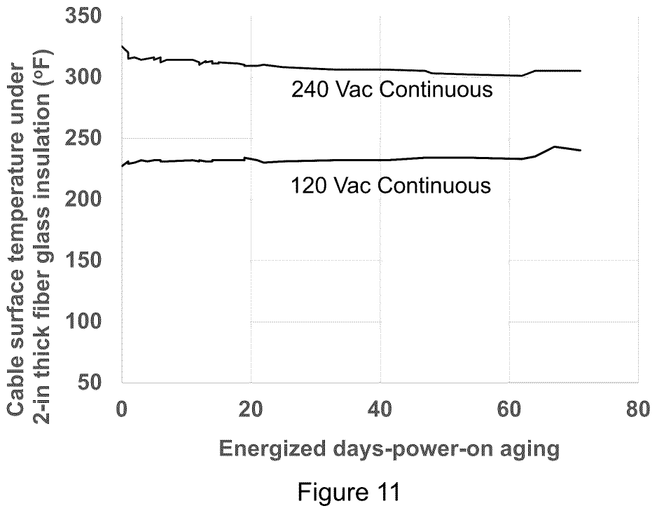

A cable manufactured according to the specifications in Table 1 was subjected to a continuously energized active test at 120 Vac and 240 Vac under 2-inch fiber glass insulation. The power was on continuously over 70 days without a thermostat controller. When the cable was powered on at 120 Vac and 240 Vac without power-on and -off, the generated heat temperatures were monitored continuously on the cable outer jacket surface under the insulation. As shown in FIG. 11, the maximum generated heat temperature of the cable was about 305° F. (152° C.) at 240 Vac and about 240° F. (116° C.) at 120 Vac, and the heat generation stopped at the intended temperature, depending on the applied voltage, demonstrating self-regulating PTC characteristics without a sign of performance compromise over the length of the test (71 days).

### Example 3

In this example embodiment, self-regulating heat tracing cables were manufactured using non-fluorinated, non-olefinic semi-crystalline polymers in accordance with broad embodiment II of the present disclosure. The detailed components and the cable specifications of this example embodiment are summarized in Table 2. As shown in Table 2, all polymeric components of the heating cable in this embodiment (i.e., the heating element, dielectric insulation, and outer jacket) were made of PEEK (from Victrex) and Polyamide 11 (from Arkema). Further, Electrolock EJ Aluminum Laminate 200 was wrapped around the dielectric insulation-extruded bare cable underneath the metallic braid mesh as a moisture barrier. Although Table 2 presents test results for PEEK, it is understood that the broader PAEK family of polymers will behave similarly to PEEK by exhibiting similar thermal expansion properties. A PAEK polymer can thus also be used to provide generally similar PTC characteristics for a self-regulating cable.

To measure initial power output, the manufactured cable of this embodiment was placed on a flow pipe test fixture at 240 Vac and a flow pipe temperature of 10° C. according to the procedure described in Example 1.

TABLE 2
Components and specifications of the SR-EHT cable of Example 3

| Component | | | | Electric | | Initial | |
|---|---|---|---|---|---|---|---|
| and No. in | | Composition | | resistance | | Power | Auto shut- |
| FIG. 2A | | of each | Component | of cable | Applied | Output (at | off |
| monolithic | Material | component | thickness | (Ω/m at | voltage | 10° C.) at | temperature |
| design | type | (wt %) | (mm) | 20° C.) | (Vac) | Vac (W/m) | at Vac (° C.) |
| Bus wires | Ni-plated | NA | | 250 | 240 | 66 | 170 |
| (1) | 16 AWG | | | | | | |
| | Cu wires | | | | | | |
| Semi- | PEEK | 85 | 0.5 | | | | |
| crystalline | (Victrex ®) | | | | | | |
| PTC | Medium | 15 | | | | | |
| heating | conductive | | | | | | |
| element (2) | carbon | | | | | | |
| | black | | | | | | |
| Semi- | Polyamide | 100 | 2 | | | | |
| crystalline | 11 | | | | | | |
| dielectric | (Rilsan ®) | | | | | | |
| insulation | | | | | | | |
| (3) | | | | | | | |
| Polymer | Electrolock | 100 | 0.051 | | | | |
| coated | EJ | | | | | | |
| Aluminum | Aluminum | | | | | | |
| film wrap | Laminate | | | | | | |
| underneath | 200 | | | | | | |
| Braid (4) | Ni-plated | 100 | 0.5 | | | | |
| | Cu wire | | | | | | |
| | braid | | | | | | |
| Semi- | Polyamide | 100 | 0.25 | | | | |
| crystalline | 11 | | | | | | |
| outer jacket | (Rilsan ®) | | | | | | |
| (5) | | | | | | | |
| Additional | None | Not used | NA | | | | |
| outer jacket | | | | | | | |
| (6) | | | | | | | |

### Example 4

In this example embodiment, the self-regulating cable manufactured according to the specifications in Table 2 was subjected to a hot-cold cycling test according to the procedure described in Example 2. The cycling test results confirmed that the PTC characteristic of the cable remained intact. Other aging behaviors also remained similar to those demonstrated in Example 2.

### Example 5

In this example embodiment, self-regulating heat tracing cables were manufactured using a blend of non-fluorinated, non-olefinic semi-crystalline polymers and non-fluorinated, non-olefinic amorphous polymers in accordance with broad embodiment III of the present disclosure. The detailed components and the cable specifications for this particular embodiment are summarized in Table 3. As shown in Table 3, the polymeric components of the heating element and dielectric insulation of this embodiment were a blend of PEEK and PEI-Si.

As for the outer jacket, an amorphous silicone elastomer was extruded over the braided cable and was cured in the same extrusion-like process, using an inline radiant tubular heating oven. Further, an additional outer jacket made of PEEK (thickness of 0.2 mm) was extruded over the outer jacket for additional protection against chemical attacks and physical damage.

TABLE 3
Components and specifications of the SR-EHT cable of Example 5

| | | | | | | Initial | |
|---|---|---|---|---|---|---|---|
| | | | | | | Power | |
| Component | | | | Electric | | Output | |
| and No. in | | Composition | | resistance | | (at | Auto shut- |
| FIG. 2A | | of each | Component | of cable | Applied | 10° C.) at | off |
| monolithic | | component | thickness | (Ω/m at | voltage | Vac | temperature |
| design | Material type | (wt %) | (mm) | 20° C.) | (Vac) | (W/m) | at Vac (° C.) |
| Bus wires | Ni-plated 16 | NA | | 1800 | 240 | 36 | 250° C. |
| (1) | AWG Cu wires | | | | | | |
| Polymer | PEEK | 60 | 0.3 | | | | |
| blend of | (VESTAKEEP ®) | | | | | | |
| amorphous | PEI-Si | 26 | | | | | |
| and semi- | Medium | 14 | | | | | |
| crystalline | conductive | | | | | | |
| PTC | carbon black | | | | | | |
| heating | | | | | | | |
| element (2) | | | | | | | |
| Polymer | PEEK | 70 | 1.15 | | | | |
| blend for | (VESTAKEEP ®) | | | | | | |
| toughened | PEI-Si | 30 | | | | | |
| dielectric | | | | | | | |
| insulation | | | | | | | |
| (3) | | | | | | | |
| Braid (4) | Ni-plated Cu | 100 | 0.5 | | | | |
| | wire braid | | | | | | |
| Amorphous | Silicone (Si) | 100 | 0.35 | | | | |
| outer jacket | thermoset | | | | | | |
| (5) | elastomer | | | | | | |
| | compound | | | | | | |
| Additional | PEEK | 100 | 0.2 | | | | |
| outer jacket | (VESTAKEEP ®) | | | | | | |
| (6) | | | | | | | |

### Example 6

In this example embodiment, a self-regulating cable manufactured according to the specifications in Table 3 was subjected to a hot-cold cycling test according to the procedure described in Example 2. The cycling test results confirmed that the PTC characteristic of the cable remained intact. Other aging behaviors also remained similar to those demonstrated in Example 2.

### Example 7

In this example embodiment, self-regulating heat tracing cables were manufactured using a different blend of non-fluorinated, non-olefinic semi-crystalline polymers and non-fluorinated, non-olefinic amorphous polymers in accordance with broad embodiment III of the present disclosure. The detailed components and the cable specifications for this example embodiment are summarized in Table 4. As shown in Table 4, the polymeric components of the heating element, dielectric insulation, and outer jacket for this embodiment were a blend of PEEK to increase toughness and PEI-Si to increase flexibility.

Further, in this embodiment, a super conductive grade of carbon black with a surface area of approximately 800 m²/g (BET) was mixed in the polymeric blend of the heating element. As shown in Table 4, a lower amount of the super conductive carbon black (7 wt %) was needed compared to other example embodiments. This lower concentration of carbon black also enhances the flexibility of the heating element.

TABLE 4
Components and specifications of the SR-EHT cable of Example 7

| | | | | | | Initial | |
|---|---|---|---|---|---|---|---|
| | | | | | | Power | |
| Component | | | | Electric | | Output | |
| and No. in | | Composition | | resistance | | (at | Auto shut- |
| FIG. 2A | | of each | Component | of cable | Applied | 10° C.) | off |
| monolithic | | component | thickness | (Ω/m at | voltage | at Vac | temperature |
| design | Material type | (wt %) | (mm) | 20° C.) | (Vac) | (W/m) | at Vac (° C.) |
| Bus wires | Ni-plated 16 | NA | | 300 | 120 | 50 | 175 |
| (1) | AWG Cu wires | | | | | | |
| Polymer | PEEK | 23 | 0.7 | | | | |
| blend of | (VESTAKEEP ®) | | | | | | |
| amorphous | PEI-Si | 70 | | | | | |
| and semi- | Super conductive | 7 | | | | | |
| crystalline | carbon black | | | | | | |
| PTC | | | | | | | |
| heating | | | | | | | |
| element (2) | | | | | | | |
| Polymer | PEEK | 50 | 1.5 | | | | |
| blend for | (VESTAKEEP ®) | | | | | | |
| toughened | PEI-Si | 50 | | | | | |
| dielectric | | | | | | | |
| insulation | | | | | | | |
| (3) | | | | | | | |
| Braid (4) | Ni-plated Cu | 100 | 0.5 | | | | |
| | wire braid | | | | | | |
| Polymer | PEEK | 50 | 1.0 | | | | |
| blend of | (VESTAKEEP ®) | | | | | | |
| amorphous | PEI-Si | 50 | | | | | |
| and semi- | | | | | | | |
| crystalline | | | | | | | |
| outer jacket | | | | | | | |
| (5) | | | | | | | |
| Optional | None | Not used | NA | | | | |
| jacket (6) | | | | | | | |

### Example 8

In this example embodiment, a self-regulating cable manufactured according to the specifications in Table 4 was subjected to hot-cold cycling testing according to the procedure described in Example 2. The cycling test results confirmed that PTC characteristics of the cable remained intact with the use of super conductive carbon black at 7 wt %. Other aging behaviors also remained similar to those demonstrated in Example 2. The elastic modulus of the heating element with the composition shown Table 4 is expected to be lower than the heating element with the compositions shown in Tables 2 and 3 (e.g., by about 60% and about 40%, respectively).

### Example 9

In this example embodiment, a self-regulating heat tracing cable was manufactured in a fiber-wrapped design as illustrated in FIG. 2B using various blends of non-fluorinated, non-olefinic semi-crystalline polymers and non-fluorinated, non-olefinic amorphous polymers in accordance with broad embodiment III of the present disclosure. The detailed components and the cable specifications for this example embodiment are summarized in Table 5.

As shown in Table 5, the polymeric component of the fiber heating element was made of a blend of semi-crystalline PEEK and amorphous PEI-Si. This PTC heating polymeric fiber was wrapped over metallic bus wires separated by an electrically non-conductive spacer. When the voltage current was applied to the metallic bus wires, the electric current transferred from the metallic bus wires to the wrapped polymeric PTC fiber to generate heat in the polymeric fiber heating element.

TABLE 5
Components and specifications of the SR-EHT cable of Example 9

| Component | | | | | | | |
|---|---|---|---|---|---|---|---|
| and No. in | | | | Electric | | Initial | |
| FIG. 2B | | Composition | | resistance | | Power | Auto shut- |
| fiber- | | of each | Component | of cable | Applied | Output (at | off |
| wrapped | Material | component | Dimension | (Ω/m at | voltage | 10° C.) at | temperature |
| design | type | (wt %) | (mm) | 20° C.) | (Vac) | Vac (W/m) | at Vac (° C.) |
| Bus wires | Ni-plated | NA | | 400 | 220 | 66 | 190 |
| (1) | 14 AWG | | | | | | |
| | Cu wires | | | | | | |
| A blend of | Semi- | 48 | Width: | | | | |
| semi- | crystalline | | 2 mm | | | | |
| crystalline | PEEK | | Height: | | | | |
| and | Amorphous | 32 | 3 mm | | | | |
| amorphous | PEI-Si | | | | | | |
| spacer (7) | Fiber glass | 20 | | | | | |
| Polymer | Semi- | 40 | Fiber | | | | |
| blend of | crystalline | | diameter: | | | | |
| amorphous | PEEK | | 1 mm | | | | |
| and semi- | Amorphous | 40 | The | | | | |
| crystalline | PEI-Si | | number of | | | | |
| PTC | Medium | 20 | fiber wraps | | | | |
| heating | conductive | | in 10 cm | | | | |
| element (2) | carbon | | length: 5 | | | | |
| | black | | | | | | |
| Amorphous | Silicone | 100 | Thickness: | | | | |
| dielectric | elastomer | | 1.2 mm | | | | |
| insulation | | | | | | | |
| (3) | | | | | | | |
| Braid (4) | Ni-plated | 100 | Thickness: | | | | |
| | Cu wire | | 0.5 mm | | | | |
| | braid | | | | | | |
| Semi- | Polyamide | 100 | Thickness: | | | | |
| crystalline | 6.6 | | 0.5 mm | | | | |
| outer jacket | | | | | | | |
| (5) | | | | | | | |
| Optional | None | Not used | NA | | | | |
| jacket (6) | | | | | | | |

### Example 10

Example 10 is another example of a fiber-wrapped SR-EHT cable. In this example embodiment, a self-regulating heat tracing cable was manufactured in the form of a fiber-wrapped design using non-fluorinated, non-olefinic amorphous polymers in accordance with broad embodiment I of the present disclosure. The detailed components and the cable specifications for this example embodiment are summarized in Table 6.

TABLE 6
Components and specifications of the SR-EHT cable of Example 10

| Component | | | | | | | |
|---|---|---|---|---|---|---|---|
| and No. in | | | | Electric | | Initial | |
| FIG. 2B | | Composition | | resistance | | Power | Auto shut- |
| fiber- | | of each | Component | of cable | Applied | Output (at | off |
| wrapped | Material | component | Dimension | (Ω/m at | voltage | 10° C.) at | temperature |
| design | type | (wt %) | (mm) | 20° C.) | (Vac) | Vac (W/m) | at Vac (° C.) |
| Bus wires | Ni-plated | NA | | 100 | 120 | 50 | 170 |
| (1) | 16 AWG | | | | | | |
| | Cu wires | | | | | | |
| Amorphous | Silicone | 60 | Width: | | | | |
| spacer (7) | elastomer | | 2.5 mm | | | | |
| | Fumed | 40 | Height: | | | | |
| | silica | | 3.5 mm | | | | |
| Amorphous | PEI-Si | 70 | Fiber | | | | |
| PTC | Low | 30 | diameter: | | | | |
| heating | conductive | | 0.7 mm | | | | |
| fiber | carbon | | The | | | | |
| element | black | | number of | | | | |
| wrapping | | | fiber turns | | | | |
| (2) | | | in 10 cm | | | | |
| | | | length: 3 | | | | |
| Amorphous | Silicone | 70 | Thickness: | | | | |
| dielectric | elastomer | | 0.8 mm | | | | |
| insulation | Fumed | 30 | | | | | |
| (3) | silica | | | | | | |
| Braid (4) | Tin-plated | 100 | Thickness: | | | | |
| | Cu wire | | 0.5 mm | | | | |
| | braid | | | | | | |
| Amorphous | Silicone | 50 | Thickness: | | | | |
| outer jacket | elastomer | | 0.5 mm | | | | |
| (5) | Fumed | 50 | | | | | |
| | silica | | | | | | |
| Optional | PEI-Si | 100 | Thickness: | | | | |
| amorphous | | | 0.1 mm | | | | |
| jacket (6) | | | | | | | |

### Example 11

The minimum bending radius of the monolithic PFAS-free, non-olefinic SR-EHT cables manufactured according to the specifications in Tables 1, 3, and 4 was assessed at −15° C. and −60° C. according to the test method set forth in IEC/IEEE 60079-30-1:2015 5.1.7 (Cold Bend Test). Table 7 shows the minimum bending radius of these heat tracing cables, as well as the minimum bending radius of commercially available PFAS-containing SR-EHT monolithic cables HTSX® (Thermon) and QTVR® (Raychem). The minimum bending radii of the monolithic PFAS-free, non-olefinic SR-EHT cable manufactured according to the specifications in Table 1 were the same as or less than those of the commercially available cables. The minimum bending radii of the monolithic PFAS-free, non-olefinic SR-EHT cable manufactured according to the specifications in Table 3 were less than those of the QTVR® cable. The minimum bending radii of the monolithic PFAS-free, non-olefinic SR-EHT cable manufactured according to the specifications in Table 4 were the same as those of the QTVR® cable.

TABLE 7
Minimum Bending Radius at given temperature of monolithic heat tracing cables

| | PFAS High | PFAS High | | | |
|---|---|---|---|---|---|
| | Temp. SR-EHT | Temp. SR-EHT | Cable | Cable | Cable |
| | Cable - | Cable- | manufactured | manufactured | manufactured |
| | Thermon | Raychem | according to | according to | according to |
| Temperature | HTSX ® | QTVR ® | Table 1 | Table 3 | Table 4 |
| At 5° F. | 10 mm (0.38″) | 35 mm (1.4″) | 10 mm (0.38″) | 25 mm (1″) | 35 mm (1.4″) |
| (−15° C.) | | | | | |
| At −76° F. | 32 mm (1.25″) | 51 mm (2″) | 25 mm (1″) | 40 mm (1.6″) | 51 mm (2″) |
| (−60° C.) | | | | | |

It is apparent to the person skilled in the art that while the drawings in the present disclosure have illustrated self-regulating electrical heat tracing cables of certain geometries, other geometries are possible in other variants.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a self-regulating electrical heating cable comprising:
two spaced-apart electrically resistive wires extending along a length of the heating cable to generate heat from an electrical current conducted by the wires; and
a heating element extending along the length of the heating cable and electrically coupled to the wires to define a heating core, wherein the heating element comprises:
a polymer material exhibiting a positive temperature coefficient (PTC) characteristic and comprising one or more PFAS-free, non-olefinic amorphous polymers, one or more PFAS-free, non-olefinic semi-crystalline polymers, or any combination thereof; and
a thermally conductive material disposed within the polymer material to render the heating element thermally conductive to transfer the heat generated by the wires.

Embodiment 2 is the self-regulating electrical heating cable of embodiment 1, wherein the polymer material comprises one or more PFAS-free, non-olefinic amorphous polymers.

Embodiment 3 is the self-regulating electrical heating cable of embodiment 2, wherein the polymer material comprises a polyetherimide-siloxane (PEI-Si) amorphous copolymer.

Embodiment 4 is the self-regulating electrical heating cable of embodiment 2, wherein the polymer material is selected from the group consisting of PFAS-free, non-olefinic amorphous polymers.

Embodiment 5 is the self-regulating electrical heating cable of embodiment 1, wherein the polymer material comprises one or more PFAS-free, non-olefinic semi-crystalline polymers.

Embodiment 6 is the self-regulating electrical heating cable of embodiment 5, wherein the polymer material comprises a semi-crystalline polyaryletherketone (PAEK) polymer, a semi-crystalline polyamide, a thermoplastic copolyester elastomer (TPE-E), a thermoplastic polyether block amides elastomer (TPE-A), or any combination thereof.

Embodiment 7 is the self-regulating electrical heating cable of embodiment 6, wherein the polymer material comprises a polyether ether ketone (PEEK) polymer.

Embodiment 8 is the self-regulating electrical heating cable of embodiment 5, wherein the polymer material is selected from the group consisting of PFAS-free, non-olefinic semi-crystalline polymers.

Embodiment 9 is the self-regulating electrical heating cable of embodiment 1, wherein the polymer material is a polymer blend comprising one or more PFAS-free, non-olefinic amorphous polymers and one or more PFAS-free, non-olefinic semi-crystalline polymers.

Embodiment 10 is the self-regulating electrical heating cable of embodiment 9, wherein the polymer material is a polymer blend comprising:
a polyetherimide-siloxane (PEI-Si) amorphous copolymer; and
a semi-crystalline polyaryletherketone (PAEK) polymer, a semi-crystalline polyamide, thermoplastic copolyester elastomer (TPE-E), a thermoplastic polyether block amides elastomer (TPE-A), or any combination thereof.

Embodiment 11 is the self-regulating electrical heating cable of embodiment 9, wherein the polymer material is a polymer blend comprising a polyetherimide-siloxane (PEI-Si) amorphous copolymer and a semi-crystalline polyaryletherketone (PAEK) polymer.

Embodiment 12 is the self-regulating electrical heating cable of embodiment 10, wherein the polymer material is a polymer blend comprising a polyetherimide-siloxane (PEI-Si) amorphous copolymer and a semi-crystalline polyether ether ketone (PEEK) polymer.

Embodiment 13 is the self-regulating electrical heating cable of embodiment 9, wherein the polymer material is a polymer blend comprising one or more polymers selected from the group consisting of PFAS-free, non-olefinic amorphous polymers and one or more polymers selected from the group consisting of PFAS-free, non-olefinic semi-crystalline polymers.

Embodiment 14 is the self-regulating electrical heating cable of any one of embodiments 1-13, wherein the conductive material comprises 3 wt % to 40 wt % of a total weight of the heating element.

Embodiment 15 is the self-regulating electrical heating cable of any one of embodiments 1-14, wherein the thermally conductive material comprises carbon black.

Embodiment 16 is the self-regulating electrical heating cable of embodiment 15, wherein the thermally conductive material comprises super conductive carbon black, and the super conductive carbon black comprises 3 wt % to about 10 wt % or 5 wt % to 8 wt % of a total weight of the heating element.

Embodiment 17 is the self-regulating electrical heating cable of embodiment 15, wherein the thermally conductive material comprises medium conductive carbon black, and the medium conductive carbon black comprises 14 wt % to about 40 wt % or 21 wt % to 35 wt % of a total weight of the heating element.

Embodiment 18 is the self-regulating electrical heating cable of any one of embodiments 1-14, wherein the thermally conductive material comprises carbon nanotubes.

Embodiment 19 is the self-regulating electrical heating cable of any one of embodiments 1-14, wherein the thermally conductive material comprises a metallic powder.

Embodiment 20 is the self-regulating electrical heating cable of any one of embodiments 1-19, wherein the wires are spaced apart and encapsulated by the heating element.

Embodiment 21 is the self-regulating electrical heating cable of any one of embodiments 1-14, wherein the wires are spaced apart by a PFAS-free, non-olefinic polymeric spacer to form an assembly, and the heating element is in the form of a fiber wrapped around the assembly.

Embodiment 22 is the self-regulating electrical heating cable of embodiment 21, wherein the polymeric spacer is electrically non-conductive.

Embodiment 23 is the self-regulating electrical heating cable of any one of embodiments 1-22, further comprising a dielectric insulation surrounding the heating core.

Embodiment 24 is the self-regulating electrical heating cable of embodiment 23, wherein the dielectric insulation comprises a PFAS-free, non-olefinic polymeric material.

Embodiment 25 is the self-regulating electrical heating cable of embodiment 24, wherein the dielectric insulation comprises a polyetherimide-siloxane (PEI-Si) amorphous copolymer, a semi-crystalline polyaryletherketone (PAEK) polymer, a semi-crystalline polyamide, thermoplastic copolyester elastomer (TPE-E), a thermoplastic polyether block amides elastomer (TPE-A), a silicone thermoset elastomer, or any combination thereof.

Embodiment 26 is the self-regulating electrical heating cable of embodiment 25, wherein the dielectric insulation comprises a polymer blend of a polyetherimide-siloxane (PEI-Si) amorphous copolymer and a semi-crystalline polyaryletherketone (PAEK) polymer.

Embodiment 27 is the self-regulating electrical heating cable of embodiment 25, wherein the dielectric insulation comprises a semi-crystalline polyamide.

Embodiment 28 is the self-regulating electrical heating cable of any one of embodiments 23-27, further comprising a metallic braid mesh surrounding the dielectric insulation.

Embodiment 29 is the self-regulating electrical heating cable of embodiment 28, wherein the metallic braid mesh comprises copper.

Embodiment 30 is the self-regulating electrical heating cable of embodiment 29, wherein the metallic braid mesh comprises nickel-plated copper or tin-plated copper.

Embodiment 31 is the self-regulating electrical heating cable of any one of embodiments 28-30, further comprising an outer jacket surrounding the metallic braid mesh, wherein the outer jacket comprises a PFAS-free, non-olefinic polymer material.

Embodiment 32 is the self-regulating electrical heating cable of embodiment 31, wherein the outer jacket comprises a polyetherimide-siloxane (PEI-Si) amorphous copolymer, a semi-crystalline polyaryletherketone (PAEK) polymer, a semi-crystalline polyamide, a thermoplastic copolyester elastomer (TPE-E), a thermoplastic polyether block amides elastomer (TPE-A), a silicone thermoset elastomer, or any combination thereof.

Embodiment 33 is the self-regulating electrical heating cable of embodiment 32, wherein the outer jacket comprises a polymer blend of a polyetherimide-siloxane (PEI-Si) amorphous copolymer and a semi-crystalline polyaryletherketone (PAEK) polymer.

Embodiment 34 is the self-regulating electrical heating cable of embodiment 33, wherein the outer jacket comprises a polymer blend of a polyetherimide-siloxane (PEI-Si) amorphous copolymer and a semi-crystalline polyether ether ketone (PEEK) polymer.

Embodiment 35 is the self-regulating electrical heating cable of embodiment 32, wherein the outer jacket comprises a semi-crystalline polyamide.

Embodiment 36 is the self-regulating electrical heating cable of any one of embodiments 1-35, wherein the wires comprise copper.

Embodiment 37 is the self-regulating electrical heating cable of embodiment 36, wherein the wires comprise nickel-plated copper or tin-plated copper.

Embodiment 38 is the self-regulating electrical heating cable of embodiment 1, wherein the polymer material consists essentially of one or more PFAS-free, non-olefinic amorphous polymers, one or more PFAS-free, non-olefinic semi-crystalline polymers, or any combination thereof.

Embodiment 39 is the self-regulating electrical heating cable of any one of embodiments 1-38, wherein the self-regulating electrical heat tracing cable is configured to work at service temperatures from about 100° C. to about 300° C.

Embodiment 40 is a heat trace system comprising:
the self-regulating electrical heating cable of any one of embodiments 1-39; and
a heat trace thermostat electrically coupled to a power source and to the self-regulating electrical heating cable for regulating the electrical current flowing into the self-regulating electrical heating cable.

Embodiment 41 is a method of making the self-regulating electrical heating cable of any one of embodiments 1-40, the method comprising:
spacing apart the two electrically resistive wires; and
electrically coupling the two electrically resistive wires with the heating element to form a heating core.

Embodiment 42 is the method of embodiment 41, wherein electrically coupling the two electrically resistive wires with the heating element comprises spacing apart and encapsulating the two electrically resistive wires with the heating element.

Embodiment 43 is the method of embodiment 41, wherein the heating element is in the form of a fiber, and electrically coupling the two electrically resistive wires with the heating element comprises:
spacing apart the two electrically resistive wires with an electrically non-conductive spacer to form an assembly, wherein the two electrically resistive wires comprise outer edges of the assembly; and
wrapping the assembly with spaced-apart turns of the heating element to form the heating core.

All publications described or mentioned in this disclosure are incorporated herein by reference.

For the purposes of interpreting this specification, when referring to elements of various embodiments of the present invention, the articles “a”, “an”, “the” and “said” are intended to mean that there are one or more of the elements. The terms “comprising”, “including”, “having”, “entailing” and “involving”, and verb tense variants thereof, are intended to be inclusive and open ended by which it is meant that there may be additional elements other than the listed elements.

This invention has been described in terms of specific implementations and configurations which are intended to be exemplary only. Persons of ordinary skill in the art will appreciate that many obvious variations, refinements and modifications may be made without departing from the inventive concepts presented in this application. The scope of the exclusive right sought by the Applicant(s) is therefore intended to be limited solely by the appended claims. Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A self-regulating electrical heating cable comprising:
two spaced-apart electrically resistive wires extending along a length of the heating cable to generate heat from an electrical current conducted by the wires; and
a heating element extending along the length of the heating cable and electrically coupled to the wires to define a heating core, wherein the heating element comprises:
a polymer material exhibiting a positive temperature coefficient (PTC) characteristic and comprising one or more PFAS-free, non-olefinic amorphous polymers, one or more PFAS-free, non-olefinic semi-crystalline polymers, or any combination thereof; and
a thermally conductive material disposed within the polymer material to render the heating element thermally conductive to transfer the heat generated by the wires.

2. The self-regulating electrical heating cable of claim 1, wherein the polymer material comprises one or more PFAS-free, non-olefinic amorphous polymers.

3. The self-regulating electrical heating cable of claim 2, wherein the polymer material comprises a polyetherimide-siloxane (PEI-Si) amorphous copolymer.

4. The self-regulating electrical heating cable of claim 2, wherein the polymer material is selected from the group consisting of PFAS-free, non-olefinic amorphous polymers.

5. The self-regulating electrical heating cable of claim 1, wherein the polymer material comprises one or more PFAS-free, non-olefinic semi-crystalline polymers.

6. The self-regulating electrical heating cable of claim 5, wherein the polymer material comprises a semi-crystalline polyaryletherketone (PAEK) polymer, a semi-crystalline polyamide, a thermoplastic copolyester elastomer (TPE-E), a thermoplastic polyether block amides elastomer (TPE-A), or any combination thereof.

7. The self-regulating electrical heating cable of claim 6, wherein the polymer material comprises a polyether ether ketone (PEEK) polymer.

8. The self-regulating electrical heating cable of claim 5, wherein the polymer material is selected from the group consisting of PFAS-free, non-olefinic semi-crystalline polymers.

9. The self-regulating electrical heating cable of claim 1, wherein the polymer material is a polymer blend comprising one or more PFAS-free, non-olefinic amorphous polymers and one or more PFAS-free, non-olefinic semi-crystalline polymers.

10. The self-regulating electrical heating cable of claim 9, wherein the polymer material is a polymer blend comprising:
a polyetherimide-siloxane (PEI-Si) amorphous copolymer; and
a semi-crystalline polyaryletherketone (PAEK) polymer, a semi-crystalline polyamide, thermoplastic copolyester elastomer (TPE-E), a thermoplastic polyether block amides elastomer (TPE-A), or any combination thereof.

11. The self-regulating electrical heating cable of claim 9, wherein the polymer material is a polymer blend comprising a polyetherimide-siloxane (PEI-Si) amorphous copolymer and a semi-crystalline polyaryletherketone (PAEK) polymer.

12. The self-regulating electrical heating cable of claim 10, wherein the polymer material is a polymer blend comprising a polyetherimide-siloxane (PEI-Si) amorphous copolymer and a semi-crystalline polyether ether ketone (PEEK) polymer.

13. The self-regulating electrical heating cable of claim 10, wherein the polymer material is a polymer blend comprising one or more polymers selected from the group consisting of PFAS-free, non-olefinic amorphous polymers and one or more polymers selected from the group consisting of PFAS-free, non-olefinic semi-crystalline polymers.

14. The self-regulating electrical heating cable of claim 1, wherein the conductive material comprises 3 wt % to 40 wt % of a total weight of the heating element.

15. The self-regulating electrical heating cable of claim 1, wherein the thermally conductive material comprises carbon black, carbon nanotubes, or a metallic powder.

16. The self-regulating electrical heating cable of claim 15, wherein the thermally conductive material comprises super conductive carbon black, and the super conductive carbon black comprises 3 wt % to about 10 wt % or 5 wt % to 8 wt % of a total weight of the heating element.

17. The self-regulating electrical heating cable of claim 15, wherein the thermally conductive material comprises medium conductive carbon black, and the medium conductive carbon black comprises 14 wt % to about 40 wt % or 21 wt % to 35 wt % of a total weight of the heating element.

18. The self-regulating electrical heating cable of claim 1, wherein the wires are spaced apart and encapsulated by the heating element.

19. The self-regulating electrical heating cable of claim 1, wherein the wires are spaced apart by a PFAS-free, non-olefinic electrically non-conductive polymeric spacer to form an assembly, and the heating element is in the form of a fiber wrapped around the assembly.

20. The self-regulating electrical heating cable of claim 1, further comprising a dielectric insulation surrounding the heating core, wherein the dielectric insulation comprises a PFAS-free, non-olefinic polymeric material.

21. The self-regulating electrical heating cable of claim 20, further comprising a metallic braid mesh surrounding the dielectric insulation and an outer jacket surrounding the metallic braid mesh, wherein the outer jacket comprises a PFAS-free, non-olefinic polymer material.

22. The self-regulating electrical heating cable of claim 1, wherein the polymer material consists essentially of one or more PFAS-free, non-olefinic amorphous polymers, one or more PFAS-free, non-olefinic semi-crystalline polymers, or any combination thereof.

23. The self-regulating electrical heating cable of claim 1, wherein the self-regulating electrical heat tracing cable is configured to work at service temperatures from about 100° C. to about 300° C.

24. A heat trace system comprising:
the self-regulating electrical heating cable of claim 1; and
a heat trace thermostat electrically coupled to a power source and to the self-regulating electrical heating cable for regulating the electrical current flowing into the self-regulating electrical heating cable.

25. A method of making the self-regulating electrical heating cable of claim 1, the method comprising:
spacing apart the two electrically resistive wires; and
electrically coupling the two electrically resistive wires with the heating element to form a heating core.

26. The method of claim 25, wherein electrically coupling the two electrically resistive wires with the heating element comprises:
spacing apart and encapsulating the two electrically resistive wires with the heating element; or
wherein the heating element is in the form of a fiber, and electrically coupling the two electrically resistive wires with the heating element comprises:
spacing apart the two electrically resistive wires with an electrically non-conductive spacer to form an assembly, wherein the two electrically resistive wires comprise outer edges of the assembly; and
wrapping the assembly with spaced-apart turns of the heating element to form the heating core.
